(19) United States
(12) Patent Application Publication
(10) Pub. No.: US 2016/0332352 A1
(43) Pub. Date: Nov. 17, 2016

(54) MULTI-MATERIAL MOLDING MACHINE

(71) Applicant: FANUC Corporation, Yamanashi (JP)

(72) Inventor: Tatsuhiro UCHIYAMA, Yamanashi (JP)

(21) Appl. No.: 15/153,743

(22) Filed: May 13, 2016

(30) Foreign Application Priority Data
May 15, 2015 (JP) 2015-100248

(51) Int. Cl. B29C 45/80; B29C 45/00

(52) U.S. Cl. CPC B29C 45/80; B29C 45/0003

(57) ABSTRACT

There is provided a multi-material molding machine performing multi-material molding, and when it is detected that an injection molding machine and an injection unit are not mechanically connected to each other, an operation of the injection unit is regulated. As a result, even if the injection unit is separated from an injection molding machine body, risk of a work in maintenance and repair works of the injection unit can be reduced.

### BACKGROUND OF THE INVENTION

1. Field of the Invention

The present invention relates to a multi-material molding machine and particularly to a multi-material molding machine including an injection molding machine and an injection unit and performing multi-material molding.

2. Description of the Related Art

In the injection molding machine, in order to perform molding using materials in two colors or more or different materials, a plurality of injection units are provided in one injection molding machine, and injection is performed sequentially by these plurality of injection units so as to mold an integral molding product from the materials in two colors or more or from the different materials. In this type of molding, the plurality of injection units are arranged around a mold, resins of different materials or resins in different colors are used in the respective injection units, and the resins are injected into the mold so as to perform molding.

A technology disclosed in Japanese Patent Laid-Open No. 2001-79877 includes a general-purpose injection molding machine and an injection unit provided around the general-purpose injection molding machine, and the general-purpose injection molding machine and the injection unit are mechanically connected to each other. Either one of a control device of the general-purpose injection molding machine and a control device of the injection unit links the general-purpose injection molding machine and the injection unit with each other and causes an operation start signal and an operation completion signal to be transmitted/received between the general-purpose molding machine and the injection unit. As a result, a series of continuous operations of a molding process is performed by linking the general-purpose injection molding machine and the injection unit with each other.

Moreover, in a technology disclosed in Japanese Patent Laid-Open No. 10-58479, an injection unit using an electric servomotor as a driving source is attached to a general-purpose hydraulic-driving type injection molding machine. A control section of the hydraulic-driving type injection molding machine controls also the injection unit.

In the multi-material molding machine, when the additionally provided injection unit is to be worked in maintenance or repaired, the injection unit needs to be separated from an injection molding machine body in some cases. Particularly, in those in which the injection unit is provided so as to be orthogonal to an injecting direction on an upper part of the injection molding machine as in the technologies disclosed in Japanese Patent Laid-Open No. 10-58479 and the like, if the injection unit is worked in maintenance in a state mechanically connected to the injection molding machine, there is a concern that a balance of the entire device is lost, and the device falls down. Moreover, depending on the size of the injection unit, a height of the injection unit is so high that a worker needs to do work on a ladder or a base when doing the work, which results in a concern that workability is worsened.

Thus, in order to reduce risk or to prevent worsening of the workability, it is preferable that the injection unit is separated from the injection molding machine body once and installed at a position where the work can be done easily. However, when the injection unit is separated from the injection molding machine body as above, a nozzle section for injecting the resin is exposed, and there is a concern that a high-temperature resin is splashed from the nozzle if an operation is wrong, and a dangerous situation occurs.

Moreover, if the specification of the injection molding machine to which the injection unit is connected is not compatible with the multi-material molding, or if the specification of the injection unit such as a screw diameter, a maximum injection speed, a maximum injection pressure and the like does not meet the specification of the injection molding machine to be connected such as a clamping force, a size of a platen, a maximum injection speed and the like, the multi-material molding cannot be realized with desired performances, or defective molding can occur.

The technologies disclosed in Japanese Patent Laid-Open No. 2001-79877 and Japanese Patent Laid-Open No. 10-58479 disclose that the injection molding machine and the injection unit are linked with each other and controlled by a single control device but do not disclose that a connection state of the injection unit is detected and an operation is performed.

### SUMMARY OF THE INVENTION

The present invention has an object to provide a multi-material molding machine which can reduce risk of a work in maintenance and repair works of an injection unit even if the injection unit is separated from an injection molding machine body.

The multi-material molding machine of the present invention is a multi-material molding machine including an injection molding machine and an injection unit which can be mechanically connected to the injection molding machine and includes a control device, the multi-material molding machine performing multi-material molding, in which the control device of the injection unit includes connection detecting means for detecting whether or not the injection molding machine and the injection unit are mechanically connected to each other and operation regulating means for regulating an operation of the injection unit, and the operation regulating means regulates the operation of the injection unit when the connection detecting means detects that the injection molding machine and the injection unit are not mechanically connected to each other.

As a result, even if the injection unit is separated from the injection molding machine body, the risk of the work in the maintenance or repair works of the injection unit can be reduced. Moreover, since the removed injection unit is not completely powered off, it can be operated as necessary in the maintenance or repair works of the injection unit.

The operation regulating means may regulate the operation of the injection unit by shutting off power of driving means for driving an operation section of the injection unit.

As a result, the risk of the work in the maintenance or repair works of the injection unit can be reduced.

The operation regulating means may regulate the operation of the injection unit by limiting a speed of the driving means for driving the operation section of the injection unit so that it does not exceed a predetermined speed.

As a result, the risk of the work in the maintenance or repair works of the injection unit can be reduced.

It may be so configured that electric connecting means which can electrically connect the injection molding machine and the injection unit to each other only in a predetermined range is provided, and the connection detecting means detects whether or not the injection molding machine and the injection unit are mechanically connected to each other by a connection state of the electric connecting means.

As a result, since the connection of the electric connecting means needs to be disconnected when the injection unit is to be separated from the injection molding machine, the connection between the injection molding machine body and the injection unit can be reliably disconnected.

The electric connecting means may be configured capable of connection only if physical shapes of the injection molding machine and the injection units match each other.

As a result, a trouble caused by erroneous connection of a non-matching injection unit can be prevented from occurring.

The electric connecting means may be configured to have at least two or more signal systems, and if the connection detecting means detects that a signal state differs in each system, the connection detecting means detects that the injection molding machine and the injection unit are not mechanically connected to each other.

As a result, reliability of a signal between the injection molding machine and the injection unit can be improved.

By means of the present invention, the multi-material molding machine can be provided which can reduce the risk of work in the maintenance or repair works of the injection unit even if the injection unit is separated from the injection molding machine body.

### BRIEF DESCRIPTION OF THE DRAWINGS

The aforementioned and other objects and features of the present invention will be made apparent from description of an embodiment below by referring to the attached drawings. In those figures:

FIG. 1 is a block diagram illustrating constitution of an injection unit of an embodiment of the present invention;

FIG. 2 is a view illustrating constitution of an injection molding machine and the injection unit in this embodiment;

FIG. 3 is a view illustrating an example of a sectional shape of a plug for determining connection/separation of this embodiment; and

FIG. 4 is a view illustrating an example of the sectional shape of a plug for determining connection/separation of another embodiment of the present invention.

### DETAILED DESCRIPTION OF THE PREFERRED EMBODIMENTS

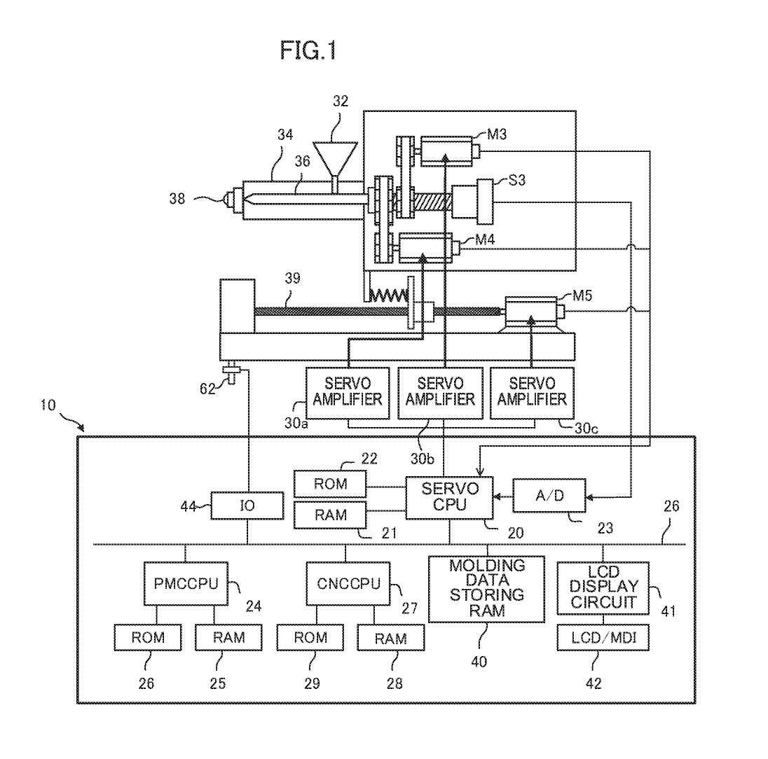

FIG. 1 is a block diagram illustrating constitution of an injection unit 60 of this embodiment. The injection unit 60 generally includes only an injecting device on a machine base.

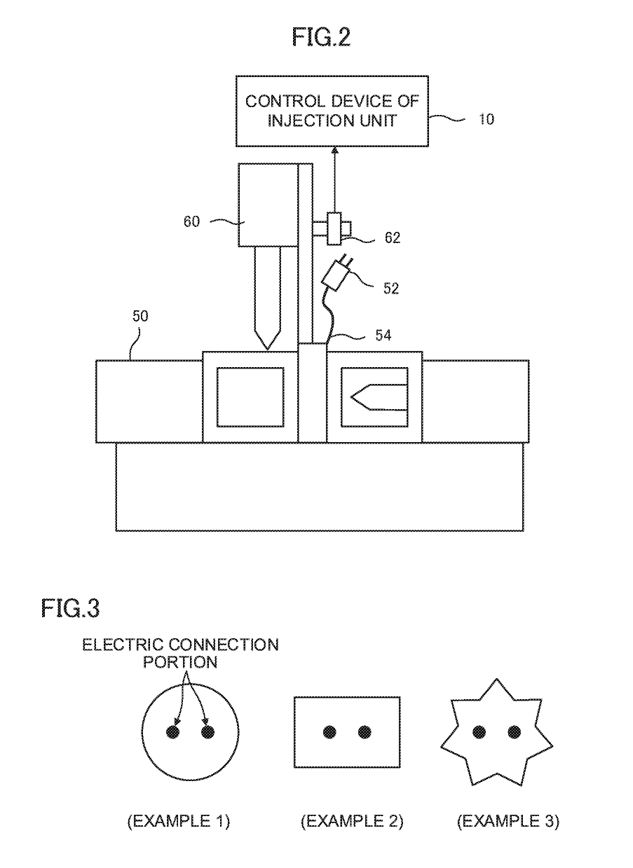

The injecting device is constituted mainly by a hopper 32 storing a resin, an injection cylinder 34, a screw 36 provided in the injection cylinder 34, and a nozzle 38 provided at a tip end of the injection cylinder 34. A ball screw 39 is also provided for moving the injection cylinder 34 and the nozzle 38 in a direction getting closer to a mold, not shown, and in a direction separated away from that on an injection molding machine 50 in FIG. 2. The resin stored in the hopper 32 is thrown into the injection cylinder 34. Then, a screw 36 is rotated by rotation of a metering motor M4, and the resin is conveyed in a direction of a tip end portion of the injection cylinder 34 while being melted by heating by a heater, not shown. A pressure inside the injection cylinder 34 at this time is detected by an injection pressure sensor S3.

Moreover, by rotating a nozzle advancing/retreating motor M5, the injection cylinder 34 and the nozzle 38 provided at the tip end thereof are advanced/retreated along the ball screw 39. By advancing the nozzle 38, the nozzle 38 is brought into contact with a mold, not shown, on the injection molding machine 50 in FIG. 2. When the nozzle 38 is brought into contact with the mold and a predetermined nozzle touch force is generated and then, by driving of an injection motor M3, the melted resin inside the injection cylinder 34 is injected into the mold. The injection motor M3, the metering motor M4, and the nozzle advancing/retreating motor M5 constitute driving means of the injection unit 60. In these motors, a position/speed detector is provided and constituted such that feedback control can be executed for operating the motor at a predetermined speed.

To each of the motors, a servo amplifier for driving each of the motors is connected. As illustrated in FIG. 1, a servo amplifier 30a controls the metering motor M4, a servo amplifier 30b controls the injection motor M3, and a servo amplifier 30c controls the nozzle advancing/retreating motor M5.

To a servo CPU 20, a ROM 22 storing a control program exclusively for servo control executing processing of a position loop, a speed loop, and a current loop and a RAM 21 used for temporary storage of data are connected.

An operation state of each motor and the like are input into the servo CPU 20. Moreover, a detected value of the injection pressure sensor S3 is input into the servo CPU 20 via an A/D (analog/digital converter) 23.

To a PMCCPU 24, a ROM 26 and a RAM 25 are connected. The ROM 26 stores a sequence program for controlling a sequence operation of the injection unit 60 and the like, and the RAM 25 is used for temporary storage of calculation data and the like. To a CNCCPU 27, a ROM 29 storing an automatic operation program for controlling the entire injection unit 60 and the like and a RAM 28 used for temporary storage of the calculation data and the like are connected.

An LCD/MDI (input device with display device) 42 having a display device constituted by a liquid crystal display device or the like is connected to a bus 26 via an LCD display circuit 41. Moreover, a molding data storing RAM 40 constituted by a non-volatile memory is also connected to the bus 26. This molding data storing RAM 40 stores molding conditions, various set values, parameters, macro variables and the like relating to an injection molding work.

By means of the constitution above, the PMCCPU 24 controls the sequence operation of the entire injection unit 60. The CNCCPU 27 distributes movement instructions to each motor on the basis of an operation program of the ROM 29 and a molding condition and the like stored in the molding data storing RAM 40, and the servo CPU 20 executes position loop control, speed loop control and moreover, servo control of the current loop control, that is, so-called digital servo processing similarly to the prior art.

Moreover, in the injection unit 60, a connection/separation determining plug 62 which will be described later is provided and is connected to the bus 26 via an I/O 44.

FIG. 2 is a view illustrating the constitution of the injection molding machine 50 and the injection unit 60 in this embodiment. In the injection molding machine 50, a connection/separation determining plug 52 is provided, and a body of the injection molding machine 50 and the connection/separation determining plug 52 are connected by a chain 54.

Moreover, the injection unit 60 is mounted on the injection molding machine 50 in a vertical direction, and a connection/separation determining plug 62 provided in the injection unit 60 is capable of connection with the connection/separation determining plug 52 provided in the injection molding machine 50. As an example, the connection/separation determining plug 52 on the injection molding machine 50 side may be made a male shape, while the connection/separation determining plug 62 on the injection unit 60 side as a female shape. It is needless to say that the male shape and the female shape may be vice versa. The connection/separation determining plug 62 is connected to a control device 10 of the injection unit 60 as illustrated in FIG. 1. When the connection/separation determining plug 62 provided in the injection unit 60 is connected to the connection/separation determining plug 52 provided in the injection molding machine 50, the control device 10 of the injection unit 60 determines that the injection unit 60 and the injection molding machine 50 are normally connected to each other, and multi-material molding is performed by a signal from the injection molding machine 50 with the injection unit 60 linked with the injection molding machine 50.

Here, the chain 54 has an appropriate length as its length, which is such a length that, in a state in which the injection unit 60 is mounted on the body of the injection molding machine 50, the connection/separation determining plug 62 provided in the injection unit 60 and the connection/separation determining plug 52 provided in the injection molding machine 50 can be connected to each other. As a result, when the injection unit 60 is to be removed from the body of the injection molding machine 50, connection of the connection/separation determining plugs (52, 62) needs to be disconnected and thus, the connection between the injection molding machine 50 and the injection unit 60 can be reliably disconnected.

Moreover, the connection/separation determining plug 52 provided on the body side of the injection molding machine 50 is preferably provided only on the injection molding machine 50 which is likely to be connected to the injection unit 60 and to perform multi-material molding. As a result, erroneous connection of the injection unit 60 to the injection molding machine 50 which is not to perform the multi-material molding, causing a trouble, can be prevented.

As a result, even an operator who does not know a method of regulating the operation of the injection unit on a numerical control device can remove the injection unit 60 from the injection molding machine 50 by physically removing the plug. Then, when works such as discharge of the resin, maintenance, inspection and the like of the injection unit 60 are to be performed, the operation of the injection unit can be reliably regulated, and risk by a mis-operation can be prevented. That is, it is only necessary that, if it is detected that the connection/separation determining plug 62 is physically removed and that a signal is not input from the connection/separation determining plug 62, the CNCCPU 27 of the injection unit 60 outputs a movement instruction to each motor so that the speed of each motor of the injection unit 60 does not exceed the predetermined speed. Even if a separate operation needs to be performed after the injection unit is removed such as discharge of the resin inside in the removed injection unit, the speed of the motor lowers to the predetermined speed or less, and the operation can be performed safely. On the other hand, there can be a case in which the control device 10 of the removed injection unit 60 is to be electrically conducted, but the motor is not to be operated for the sake of safety. In this case, the CNCCPU 27 of the injection unit 60 may prohibit an output of the movement instruction to each motor or shut off power supply to the servo amplifier (30a, 30b, 30c) when it is detected that the connection/separation determining plug 62 has been physically removed and that a signal is not input from the connection/separation determining plug 62.

FIG. 3 is a view illustrating an example of a sectional shape of the connection/separation determining plug (52, 62). For the connection/separation determining plug (52, 62), a plurality of types of plugs with connection portions having physically different shapes are prepared as illustrated in FIG. 3. Then, it is constituted that the body side of the injection molding machine 50 and the plug on the injection unit 60 side can be connected only if the specification on the injection molding machine 50 side and the specification on the injection unit 60 side match each other, and that the injection unit 60 can be operated only when it is connected. As a result, connection between the injection molding machine 50 and the injection unit 60 with different specifications can be prevented. Here, the specification of the injection molding machine 50 includes a maximum clamping force of the injection molding machine 50, a size of a platen, a diameter of a screw, a maximum injection speed, a maximum injection pressure and the like. The specification of the injection unit 60 includes the diameter of the screw, the maximum injection speed, the maximum injection pressure and the like.

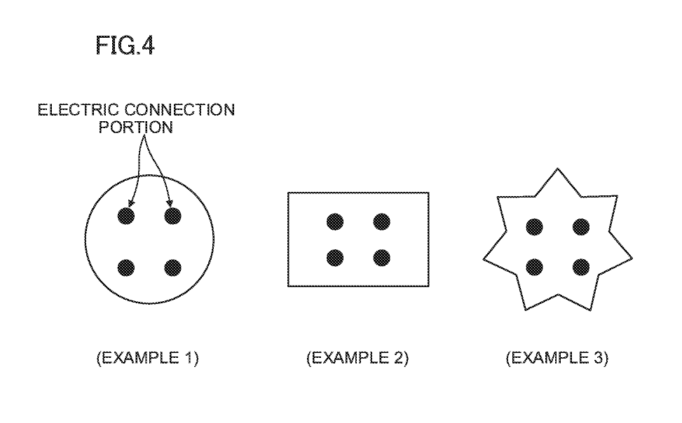

FIG. 4 is a view illustrating an example of a sectional shape of the connection/separation determining plug (52, 62) in another embodiment. In this embodiment, connection holes in pairs are provided in total of four holes. Each pair of the connection holes has a signal system different from each other, a signal is input in the signal system different according to each pair into the control device 10 of the injection unit 60, and only if the state of the both signals match each other, it is determined that the injection molding machine 50 and the injection unit 60 are connected to each other. As a result, if the control device 10 of the injection unit 60 detects the state of the signal different according to each system, it is determined that the injection unit 60 is not connected to the body of the injection molding machine 50, and the operation of the injection unit 60 is limited. A point that the body side of the injection molding machine 50 and the plug on the injection unit 60 side are made capable of connection only if the specification on the injection molding machine 50 side and the specification of the injection unit 60 side match each other, and the operation of the injection unit 60 is limited only if not connected is similar to the embodiment illustrated in FIG. 3.

1. A multi-material molding machine including an injection molding machine and an injection unit which can be mechanically connected to the injection molding machine and includes a control device, the multi-material molding machine performing multi-material molding, wherein
the control device of the injection unit includes connection detecting means for detecting whether or not the injection molding machine and the injection unit are mechanically connected to each other and operation regulating means for regulating an operation of the injection unit; and
the operation regulating means regulates the operation of the injection unit when it is detected by the connection detecting means that the injection molding machine and the injection unit are not mechanically connected to each other.

2. The multi-material molding machine according to claim 1, wherein
the operation regulating means regulates the operation of the injection unit by shutting off power of the driving means for driving an operation section of the injection unit.

3. The multi-material molding machine according to claim 1, wherein
the operation regulating means regulates the operation of the injection unit by limiting a speed of the driving means for driving an operation section of the injection unit so that the speed does not exceed a predetermined speed.

4. The multi-material molding machine according to claim 1, further comprising:
electric connecting means which can electrically connect the injection molding machine and the injection unit to each other only in a predetermined range, wherein
the connection detecting means detects whether or not the injection molding machine and the injection unit are mechanically connected to each other by a connection state of the electric connecting means.

5. The multi-material molding machine according to claim 4, wherein
the electric connecting means is capable of connection only if physical shapes of the injection molding machine and the injection unit match each other.

6. The multi-material molding machine according to claim 4, wherein
the electric connecting means has at least two or more signal systems, and if the connection detecting means detects that a signal state differs in each system, the connection detecting means detects that the injection molding machine and the injection unit are not mechanically connected to each other.
